(19) United States
(12) Patent Application Publication
(10) Pub. No.: US 2024/0242242 A1
(43) Pub. Date: Jul. 18, 2024

(54) INCENTIVE OPTIMIZATION METHOD, INCENTIVE OPTIMIZATION APPARATUS, AND PROGRAM

(71) Applicant: NIPPON TELEGRAPH AND TELEPHONE CORPORATION, Tokyo (JP)

(72) Inventors: Hideaki KIN, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 18/558,717

(22) PCT Filed: May 13, 2021
(86) PCT No.: PCT/JP2021/018182

§ 371 Date: Nov. 2, 2023

(51) Int. Cl. G06Q 30/0207

(52) U.S. Cl. CPC G06Q 30/0224

(57) ABSTRACT

An incentive optimization method according to an embodiment provides an incentive optimization method for optimizing an incentive granting method for a behavior of an individual, the incentive optimization method including being executable on a computer and including: estimating a parameter of a model for each individual, the model using the incentive granting method as input and outputting a degree of achievement with respect to a target behavior, by using a sequence of the behavior and observation data of the incentive granting method with respect to the sequence; and calculating an incentive granting method that maximizes the degree of achievement using the model in which the estimated parameter is set.

### TECHNICAL FIELD

The present invention relates to an incentive optimization method, an incentive optimization apparatus, and a program.

### BACKGROUND ART

As a conventional technique related to achievement of a target behavior or formation of a target habit based on incentives, the technique described in Non-Patent Literature 1 is known. Non-Patent Literature 1 discloses that, for the purpose of forming an exercise habit, the formation of a person's exercise habit is facilitated by granting incentives (money) according to the amount of exercise.

### CITATION LIST

### Non-Patent Literature

Non-Patent Literature 1: Finkelstein, Eric. A., et al., “A Randomized Study of Financial Incentives to Increase Physical Activity among Sedentary Older Adults”, Preventive medicine, 47(2), pp. 182-187.

### SUMMARY OF INVENTION

### Technical Problem

By the way, in achieving a certain target behavior, the magnitude of the effect of incentives is considered to vary per individual even when the amount of incentives, the number of times incentives are granted, and the timing in which incentives are granted are the same. In addition, when the period from the start of the behavior to the achievement of the target is long, the period it takes until incentives are gained upon achievement of the target becomes long, so that there is a possibility that the incentive becomes less attractive, and, as a result, the effect of incentives is reduced.

However, in the technique described in Non-Patent Literature 1, since the incentive granting method is not optimized for each individual and the influence of the period it takes until incentives are gained is not taken into account, there is a possibility that incentives are not used effectively.

An embodiment of the present invention has been made in view of the above points, and aims to optimize the method of granting incentives per individual by taking into account the period it takes until incentives are gained.

### Solution to Problem

In order to achieve the above object, an incentive optimization method according to an embodiment provides an incentive optimization method for optimizing an incentive granting method for a behavior of an individual, the incentive optimization method being executable on a computer and including: estimating a parameter of a model for each individual, the model using the incentive granting method as input and outputting a degree of achievement with respect to a target behavior, by using a sequence of the behavior and observation data of the incentive granting method with respect to the sequence; and calculating an incentive granting method that maximizes the degree of achievement using the model in which the estimated parameter is set.

### Advantageous Effects of Invention

The incentive granting method can be optimized per individual by taking into account the period it takes until incentives are gained.

### BRIEF DESCRIPTION OF DRAWINGS

FIG. 1 is a diagram for describing time discounting.

FIG. 2 is a diagram illustrating an example of a hardware configuration of an incentive optimization apparatus according to the present embodiment.

FIG. 3 is a diagram illustrating an example of a functional configuration of the incentive optimization apparatus according to the present embodiment.

FIG. 4 is a flowchart illustrating an example of incentive optimization processing according to the present embodiment.

FIG. 5 is a diagram illustrating an output example of an estimated parameter value.

FIG. 6 is a diagram illustrating an output example of a maximum degree of achievement and an optimal incentive.

### DESCRIPTION OF EMBODIMENTS

Hereinafter, an embodiment of the present invention will be described. In the present embodiment, an incentive optimization apparatus 10 capable of optimizing the method of granting incentives per individual by taking into account the period it takes until incentives are gained will be described.

Here, the incentive optimization apparatus 10 according to the present embodiment optimizes the method of granting incentives per individual by taking into account the period it takes until incentives are gained according to (1) and (2) described below.

(1) A mathematical model (hereinafter, also referred to as a “behavior model”) in which a method of granting incentives is input and the degree of achievement with respect to the target behavior is output is prepared for each individual, and the incentive granting method is optimized based on each individual's behavior model. Here, the incentive granting method includes the number of times incentives are granted, the timing of each grant, and the magnitude (amount) of incentives.

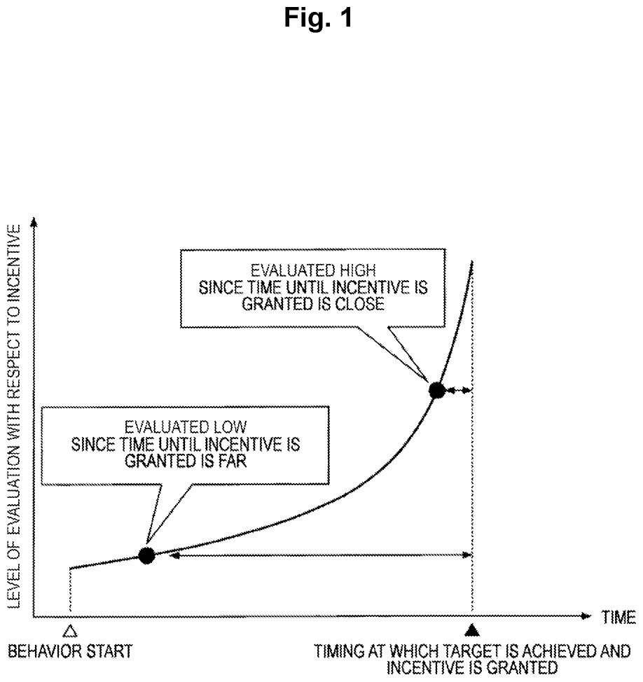

(2) In the behavior model, a behavioral economics phenomenon in which incentives to be gained in the far future are evaluated lower than incentives to be gained in the near future, that is, “time discounting,” is taken into account. Here, as illustrated in FIG. 1, time discounting is to evaluate incentives low when the time the incentives are granted is far away, and to evaluate incentives high when the time the incentives are granted is close.

### <Hardware Configuration>

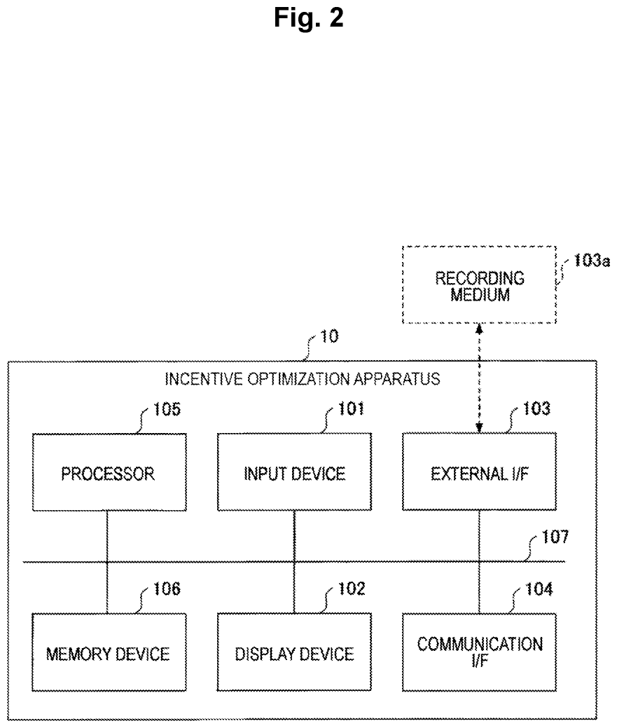

First, a hardware configuration of the incentive optimization apparatus 10 according to the present embodiment will be described with reference to FIG. 2. FIG. 2 is a diagram illustrating an example of a hardware configuration of the incentive optimization apparatus 10 according to the present embodiment.

As illustrated in FIG. 2, the incentive optimization apparatus 10 according to the present embodiment is implemented by a hardware configuration of a general computer or computer system, and includes an input device 101, a display device 102, an external I/F 103, a communication I/F 104, a processor 105, and a memory device 106. These pieces of hardware are communicably connected by a bus 107.

The input device 101 is, for example, a keyboard, a mouse, a touch panel, or the like. The display device 102 is, for example, a display or the like. Note that the incentive optimization apparatus 10 need not include, for example, at least one of the input device 101 and the display device 102.

The external I/F 103 is an interface with an external device such as a recording medium 103a. The incentive optimization apparatus 10 can, for example, read from and write in the recording medium 103a via the external I/F 103. Note that examples of the recording medium 103a include a compact disc (CD), a digital versatile disk (DVD), a secure digital memory card (SD memory card), a universal serial bus (USB) memory card, and the like.

The communication I/F 104 is an interface for connecting the incentive optimization apparatus 10 to a communication network. The processor 105 is, for example, an arithmetic device of various types such as a central processing unit (CPU) and a graphics processing unit (GPU). The memory device 106 is, for example, a storage device of various types such as a hard disk drive (HDD), a solid state drive (SSD), a random access memory (RAM), a read only memory (ROM), and a flash memory.

The incentive optimization apparatus 10 according to the present embodiment can implement incentive optimization processing described below by having the hardware configuration illustrated in FIG. 2. Note that the hardware configuration illustrated in FIG. 2 is an example, and the incentive optimization apparatus 10 may include a plurality of processors 105 or include a plurality of memory devices 106.

### <Functional Configuration>

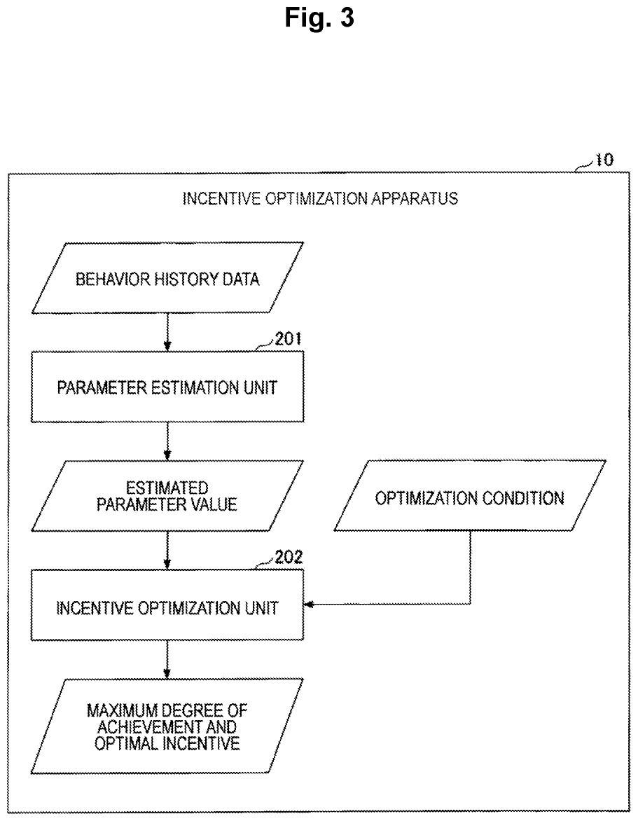

Next, a functional configuration of the incentive optimization apparatus 10 according to the present embodiment will be described with reference to FIG. 3. FIG. 3 is a diagram illustrating an example of a functional configuration of the incentive optimization apparatus 10 according to the present embodiment.

As illustrated in FIG. 3, the incentive optimization apparatus 10 according to the present embodiment includes a parameter estimation unit 201 and an incentive optimization unit 202. Each of these units is implemented by, for example, processing executed by the processor 105 by one or more programs installed in the incentive optimization apparatus 10.

The parameter estimation unit 201 estimates a parameter in each individual's behavior model by using behavior history data of each individual as input, and outputs an estimated parameter value as a result of estimation.

The incentive optimization unit 202 searches for an optimal incentive representing an incentive granting method that maximizes the degree of achievement of the target behavior, based on each individual's behavior model, by using the estimated parameter value and an optimization condition, which is a condition regarding the incentive granting method, as input, and outputs the optimal incentive and the degree of achievement (maximum degree of achievement) at that time.

Note that, in the example illustrated in FIG. 1, one incentive optimization apparatus 10 includes the parameter estimation unit 201 and the incentive optimization unit 202, but this is an example, and for example, the parameter estimation unit 201 and the incentive optimization unit 202 may be included in different devices.

### <Incentive Optimization Processing>

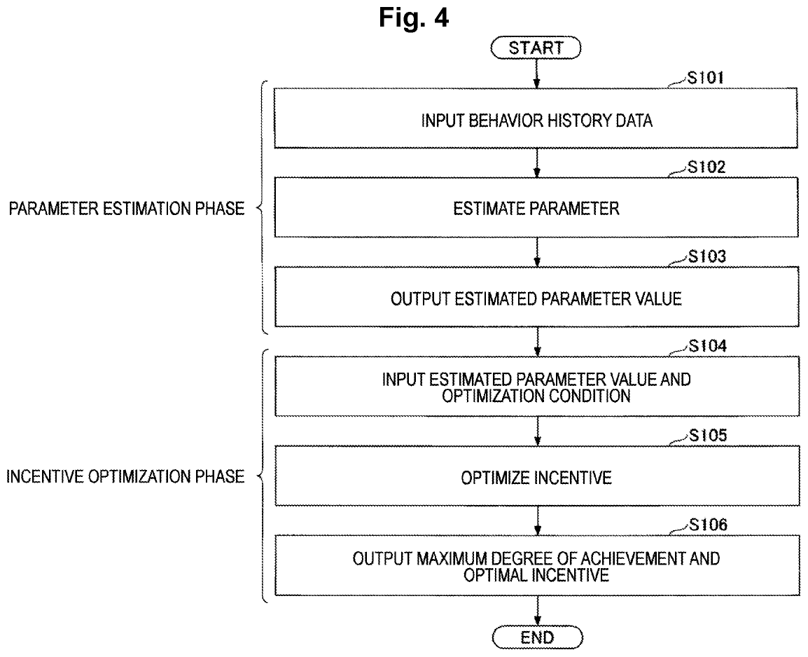

Next, the incentive optimization processing according to the present embodiment will be described with reference to FIG. 4. FIG. 4 is a flowchart illustrating an example of the incentive optimization processing according to the present embodiment. Steps S101 to S103 are a parameter estimation phase for estimating the parameter of the behavior model, and steps S104 to S106 are an incentive optimization phase for obtaining the maximum degree of achievement and an optimal incentive based on the behavior model in which the estimated parameter value is set. Note that the behavior history data of each individual is given to the incentive optimization apparatus 10 in the parameter estimation phase, and the estimated parameter value and the optimization condition are given to the incentive optimization apparatus 10 in the incentive optimization phase.

Step S101: First, the parameter estimation unit 201 inputs the behavior history data of each individual.

The behavior history data is observation data regarding the behavior of each individual (hereinafter, also referred to as a “user”), and the number of times incentives are granted, the time (or the year, month, and day, the date and time, etc.) incentives are granted, and the amount of incentives granted with respect to that behavior. An ID or the like for identifying the user is u, the total number of users is U, the length of the period of the target behavior of the user u is T^{u}, and the number of times incentives are granted as observed by the user u is N^{u}. At this time, the behavior history data includes a sequence {yₜ^{u}} of behaviors of the user u at each observation time, a sequence {sₙ^{u}} of times of grant of incentives observed by the user u, and a sequence {mₙ^{u}} of amounts of incentives granted to the user u. Here,

$$\{ {y}_{t}^{u} \} ≡ ( {y}_{1}^{u} , {y}_{2}^{u} , … , {y}_{{T}^{u}}^{u} ) \qquad [ Math . 1 ]$$

$$\{ {s}_{n}^{u} \} ≡ ( {s}_{1}^{u} , {s}_{2}^{u} , … , {s}_{{N}^{u}}^{u} )$$

$$\{ {m}_{n}^{u} \} ≡ ( {m}_{1}^{u} , {m}_{2}^{u} , … , {m}_{{N}^{u}}^{u} ) .$$

However, the observation value {yₜ^{u}} of the behavior is a numerical value gained by evaluating the goodness of the target behavior quantitatively. For example, for the purpose of forming a walking habit, the observation value of the behavior may be the number of steps per day or the like. In addition, examples of amounts of incentives include money, points, or the like.

Step S102: Next, the parameter estimation unit 201 estimates a parameter in each individual's behavior model by using the behavior history data input in step S101 described above.

The behavior model is a mathematical model in which a method of granting incentives is input and the degree of achievement with respect to the target behavior is output, and, in this step, the parameter of this behavior model is estimated for each user u.

First, a situation in which a behavior yₜ at time t of each user is given based on Formula (1) described below is considered.

$$\begin{matrix}[ Math . 2 ] & \\ {y}_{t} = σ ( {x}_{t} ) & ( 1 )\end{matrix}$$

$${x}_{t} = {\sum }_{i ∈ \{ j \vert {s}_{j} > t \}} {m}_{i} h ( t \vert {s}_{i - 1} , {s}_{i} , θ )$$

Here, sᵢ is the time (where s₀=1) incentives are granted for an i-th time, mᵢ is the amount of incentives at the i-th time, θ is a parameter, and h(t|sᵢ₋₁, sᵢ, θ) is the degree of influence of incentives granted at the i-th time on the behavior per unit amount of incentives. In particular, when time discounting is taken into account, h(t|sᵢ₋₁, sᵢ, 0) is designed to be a monotonically increasing function with respect to time t. In addition, xₜ is an internal state and is assumed to be converted into a behavior yₜ observed through a function σ(x).

Note that the degree of influence h(t|sᵢ₋₁, sᵢ, θ) on the behavior per unit amount of incentives is given by, for example, a function h(t|sᵢ₋₁, sᵢ, θ)=1/(1+θ(sᵢ₋ₜ)) considering hyperbolic discounting, or the like.

Next, an evaluation function G({yₜ}) for calculating the degree of achievement of the target behavior from a sequence {yₜ}=(y₁, y₂, . . . , y_{T}) of behaviors in a period of a length T is defined.

Degree of achievement of target behavior=G({yₜ}) (2)

The behavior model is defined by Formulae (1) and (2) described above.

Note that the evaluation function G({yₜ}) is arbitrarily designed according to the target behavior, but the degree of achievement increases as the sequence {yₜ} of behaviors approaches the target, and the degree of achievement decreases as the sequence {yₜ} of behaviors moves away from the target.

Therefore, the parameter estimation unit 201 estimates the parameter θ so as to minimize the difference Δy between the behavior predicted from the behavior model and the behavior history data. However, the parameter is estimated for each user u.

That is, the parameter estimation unit 201 estimates a parameter θ^{u} of the user u based on Formula (3) below.

$$\begin{matrix}[ Math . 3 ] & \\ {θ}^{u} = arg {min}_{θ} Δ y & ( 3 )\end{matrix}$$

$$Δ y ≡ {\sum }_{t = 1}^{{T}^{u}} {\vert {y}_{t}^{u} - σ ( {\sum }_{i ∈ \{ j \vert {s}_{j}^{u} > t \}} {m}_{t}^{u} h ( t \vert {s}_{i - 1}^{u} , {s}_{i}^{u} , θ ) ) \vert}^{γ}$$

However, γ is a non-negative value.

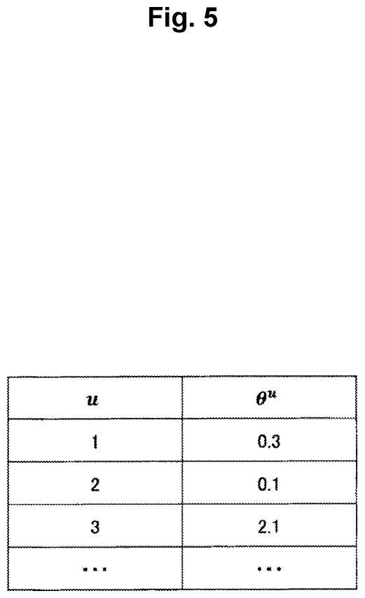

Step S103: Then, the parameter estimation unit 201 outputs the parameter θ^{u} estimated in step S102 described above as an estimated parameter value. Here, an output example of the estimated parameter value is illustrated in FIG. 5. In the example illustrated in FIG. 5, an example is illustrated in which the parameter θ^{u}=0.3 of the user u=1, the parameter θ^{u}=0.1 of the user u=2, the parameter θ^{u}=2.1 of the user u=3, and the like are output as estimated parameter values. Note that the output destination of the estimated parameter values can be arbitrarily set, and examples thereof include the display device 102, the memory device 106, and other devices connected via a communication network.

Step S104: Subsequently, the incentive optimization unit 202 inputs the estimated parameter value and the optimization condition.

Here, an incentive granting method related to the user u is Z^{u}. The incentive granting method Z^{u} includes the number of times incentives are granted N, a sequence {sₙ}≡(s₁, s₂, . . . , s_{N}) of times incentives are granted, and a sequence {mₙ}≡(m₁, m₂, . . . , M_{N}) of amounts of incentives granted to the user u. That is, Z^{u}≡(N, {sₙ}, {mₙ}). In addition, at this time, C_{z}^{u} is a condition (optimization condition) to be considered regarding the incentive granting method when optimizing the incentive granting method.

Specifically, the optimization condition G_{z}^{u} is a set of various incentive granting methods related to the user u. For example, assuming that the incentive granting method is Z, it is a set such as {Z|N=3, total amount of incentive=10,000}. This represents a set of incentive granting methods Z in which the number of times incentives are granted is three and the total amount of incentives is 10,000. The object is to search for an optimal incentive granting method (that is, a granting method that maximizes the effect of incentives (the degree of achievement of the target behavior)) from among the incentive granting methods satisfying such a certain condition. In this sense, the optimization condition G_{z}^{u} is a search space for an incentive granting method related to the user u. Note that what condition a set of incentive granting methods G_{z}^{u} satisfies is determined by the designer of incentives or the like.

Step S105: Next, the incentive optimization unit 202 calculates an optimal incentive granting method Z^{u} by using the estimated parameter value and the optimization condition input in step S104 described above. That is, the incentive optimization unit 202 searches for an optimal incentive granting method Z^{u} for the user u based on Formula (4) below.

$$\begin{matrix}[ Math . 4 ] & \\ {Z}^{u} = arg {max}_{Z ∈ {C}_{Z}^{u}} G ( \{ {y}_{t} \} ) & ( 4 )\end{matrix}$$

However, when searching for an optimal incentive granting method Z^{u} for the user u, a behavior model in which the parameter θ^{u} is set is used. Note that it suffices to search for an optimal incentive granting method Z^{u} for the user u based on a known algorithm (for example, the brute-force method or the like).

The above optimal incentive granting method Z^{u} is searched for each user u ∈{1, 2, . . . , U}. Thus, the optimal incentive and the maximum degree of achievement can be gained for each user.

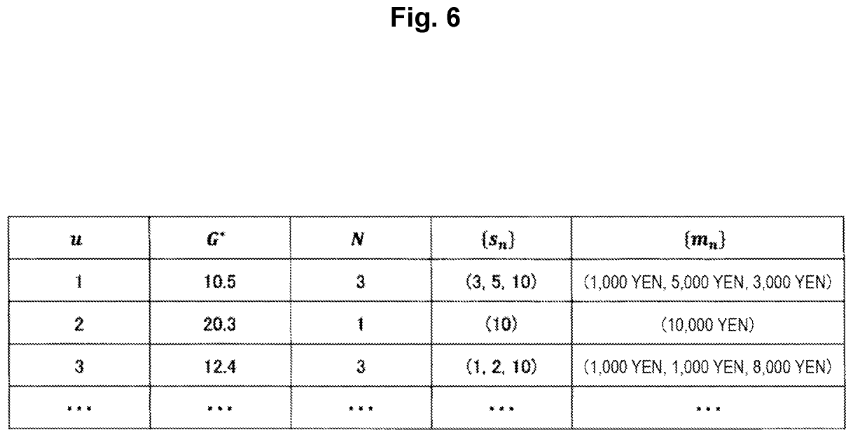

Step S106: Then, the incentive optimization unit 202 outputs the maximum degree of achievement and the optimal incentive gained in step S105 described above. Here, an output example of a maximum degree of achievement G* and an optimal incentive Z^{u}*=(N, {sₙ}, {mₙ}) is illustrated in FIG. 6. In the example illustrated in FIG. 6, an example is illustrated in which the maximum degree of achievement G*=10.5 of the user u=1, an optimal number of times to grant incentives N=3, optimal times to grant incentives (3, 5, 10), and optimal amounts of incentives (2,000 yen, 5,000 yen, 3,000 yen) at each time are output. Similarly, an example is illustrated in which the maximum degree of achievement G*=20.3 of the user u=2, an optimal number of times to grant incentives N=1, an optimal time to grant incentives (10), and an optimal amount of incentives (10,000) at each time are output. Similarly, an example is illustrated in which the maximum degree of achievement G*=12.4 of the user u=3, an optimal number of times to grant incentives N=3, optimal times to grant incentives (1, 2, 10), and optimal amounts of incentives (1,000 yen, 1,000 yen, 8,000 yen) at each time are output. In the example illustrated in FIG. 6, a condition is that the budget (that is, the total amount of incentives for each user u) of financial incentives for each user u is 10,000 yen. Note that the output destination of the maximum degree of achievement and optimal incentives can be arbitrarily set, and examples thereof include the display device 102, the memory device 106, and other devices connected via a communication network.

### Conclusion

As described above, the incentive optimization apparatus 10 according to the present embodiment creates a behavior model by taking into account the period it takes until incentives are granted to each user, and searches for an optimal incentive granting method, that is, an incentive granting method that maximizes the degree of achievement of the target behavior by using each user's behavior model. Thus, based on each individual's behavior principle for incentives, it is possible to specify the most effective incentive granting method for achieving the target behavior of each individual.

The present invention is not limited to the above embodiment specifically disclosed, and various modifications and changes, combinations with known technologies, and the like can be made without departing from the scope of the claims.

### REFERENCE SIGNS LIST

10 Incentive optimization apparatus
101 Input device
102 Display device
103 External I/F
103a Recording medium
104 Communication I/F
105 Processor
106 Memory device
107 Bus
201 Parameter estimation unit
202 Incentive optimization unit

1. An incentive optimization method for optimizing an incentive granting method for a behavior of an individual, the incentive optimization method being executable on a computer and comprising:
estimating a parameter of a model for each individual, the model using the incentive granting method as input and outputting a degree of achievement with respect to a target behavior, by using a sequence of the behavior and observation data of the incentive granting method with respect to the sequence; and
calculating an incentive granting method that maximizes the degree of achievement using the model in which the estimated parameter is set.

2. The incentive optimization method according to claim 1, wherein the model outputs the degree of achievement by taking time discounting into account, the time discounting evaluating incentives to be gained in far future lower than incentives to be gained in near future.

3. The incentive optimization method according to claim 1, wherein the incentive granting method includes a number of times to grant incentives, a date and time to grant incentives, and an amount of incentives to grant.

4. The incentive optimization method according to claim 3, wherein the incentive granting method is calculated under a condition that a total amount of incentives to grant is constant.

5. An incentive optimization apparatus for optimizing an incentive granting method for a behavior of an individual, the incentive optimization apparatus comprising:
a parameter estimation unit configured to estimate a parameter of a model for each individual, the model using the incentive granting method as input and outputting a degree of achievement with respect to a target behavior, by using a sequence of the behavior and observation data of the incentive granting method with respect to the sequence; and
an optimization unit configured to calculate an incentive granting method that maximizes the degree of achievement using the model in which the parameter estimated in the parameter estimation unit is set.

6. A non-transitory computer-readable recording medium storing a program that causes a computer to execute an incentive optimization method for optimizing an incentive granting method for a behavior of an individual, the incentive optimization method comprising:
estimating a parameter of a model for each individual, the model using the incentive granting method as input and outputting a degree of achievement with respect to a target behavior, by using a sequence of the behavior and observation data of the incentive granting method with respect to the sequence; and
calculating an incentive granting method that maximizes the degree of achievement using the model in which the estimated parameter is set.
